(19) United States
(12) Patent Application Publication
(10) Pub. No.: US 2006/0187389 A1
(43) Pub. Date: Aug. 24, 2006

(54) Liquid crystal display device

(76) Inventors: Takanori Nakayama, Mobara (JP); Atsuhiro Katayama, Mobara (JP); Kimitoshi Ohgiichi, Mobara (JP); Hidetaka Hakoda, Ichihara (JP); Eisaku Hazawa, Mobara (JP)

Correspondence Address: REED SMITH LLP;Suite 1400, 3110 Fairview Park Drive, Falls Church, VA, 22042, US

(21) Appl. No.: 11/357,196

(22) Filed: Feb. 21, 2006

(30) Foreign Application Priority Data
Feb. 23, 2005 (JP) 2005-046699

(51) Int. Cl. G02F 1/1335

(52) U.S. Cl. 349/114

(57) ABSTRACT

The present invention provides a part-transmissive liquid crystal display device which can perform the color compensation simultaneously with countermeasures to cope with flickers. In a liquid crystal display device which includes a transmissive region and a reflective region within one pixel, an electrode in the transmissive region is constituted of a transparent electrode, an electrode in the reflective region is constituted of a metal electrode, and a transparent conductive film having a film thickness of 80 nm or more and 120 nm or less is arranged on the metal electrode.

CROSS-REFERENCE TO RELATED APPLICATIONS

The disclosure of Japanese Patent Application No.2005-46699 filed on Feb. 23, 2005 including the specification, drawings and abstract is incorporated herein by reference in its entirety.

### BACKGROUND OF THE INVENTION

1. Field of the Invention

The present invention relates to a part-transmissive liquid crystal display device, and more particularly to a part-transmissive display device which includes a transmissive region and a reflective region in a pixel portion.

2. Description of the Related Arts

As an active-matrix-type liquid crystal display device which has been currently popularly used, there has been known a reflective liquid crystal display device, a transmissive liquid crystal display device, and a part-transmissive/part-reflective liquid crystal display device which combines the reflective liquid crystal display device and the transmissive liquid crystal display device (hereinafter referred to as part-transmissive liquid crystal display device). This part-transmissive liquid crystal display device is provided to realize advantages of the transmissive liquid crystal display device and the reflective liquid crystal display device using a single liquid crystal display device by forming a transmissive region which allows the transmission of light from a backlight and a reflective region which reflects an external light on a pixel portion.

In Pub. No.: U.S. 2003/0112213 (document 1), as shown in FIG. 4, a cross section of a pixel portion of the so-called part-transmissive liquid crystal display device is illustrated. The pixel portion is configured such that a metal reflection film 41 (constituted by forming an Al film on a Mo film) is arranged as a pixel electrode in a reflective region, and an ITO layer 42 is arranged as a pixel electrode in a transmissive region.

Further, in the document 1, to cope with flickers which are particularly apparently recognized with naked eyes when the part-transmissive liquid crystal display device is driven at low frequency, as shown in FIG. 5, there is described the constitution in which a surface of a reflective electrode 51 (Al) which is arranged in the reflective region, is covered with an amorphous transparent conductive film 52 which is formed of an oxide (a work function thereof being approximately 4.8 eV) containing InZnOx (Indium Oxide (In₂0₃)) and zinc oxide (ZnO) as main components. Here, numeral 53 in FIG. 5 indicates an ITO film which constitutes a transmissive region.

Further, in the document 1, there exists a description that by setting a film thickness of the amorphous transparent conductive film which covers the reflective electrode to 1 nm or more and 20 nm or less, a uniform film thickness can be formed thus enabling the acquisition of a favorable display quality.

Further, in the document 1, there exists a description that when the film thickness of the amorphous transparent conductive film which covers the reflective electrode amounts to several hundreds nm, a reflective light on the reflective electrode becomes week due to the absorption of light attributed to the amorphous transparent conductive film and, at the same time, an irradiation light is colored due to the interference between light which is reflected on a surface of the amorphous transparent conductive film and light which is reflected on the reflective electrode whereby the display quality is lowered.

### SUMMARY OF THE INVENTION

In the document 1, there exists a description that as the measure to cope with flickers in the part-transmissive liquid crystal display device, the amorphous transparent conductive film is arranged on the reflective electrode in the reflective region. However, such constitution is mainly provided for preventing the coloring of the irradiation light due to the interference between the light which is reflected on the surface of the amorphous transparent conductive film and the light which is reflected on the reflective electrode. That is, the constitution is not intended to color the irradiation light with desired color to the contrary for adjusting color tones in the reflective display to the contrary.

Accordingly, it is an object of the present invention to provide a liquid crystal display device which can perform the color compensation for the adjustment of color tones in a reflective display while coping with flickers which are generated at the time of switching the turning/extinguishing of a backlight, that is, at the time of switching reflection/transmission in a part-transmissive liquid crystal display device simultaneously.

According to one aspect of the present invention, in a liquid crystal display device which includes a transmissive region and a reflective region within one pixel, a pixel electrode in the transmissive region is formed of a transparent electrode, a pixel electrode in the reflective region is formed of a metal electrode, and a transparent conductive film having a film thickness of 80 nm or more and 120 nm or less is arranged on the metal electrode.

Due to such a constitution, it is possible to provide the liquid crystal display device which can perform the color compensation for adjustment of color tones in a reflective display while coping with flickers simultaneously.

According to another aspect of the present invention, in a liquid crystal display device which includes a transmissive region and a reflective region within one pixel, a pixel electrode in the transmissive region is formed of a transparent electrode, a pixel electrode in the reflective region is formed of a metal electrode, and a transparent conductive film having a film thickness of 90 nm or more and 110 nm or less is arranged on the metal electrode.

Due to such a constitution, it is possible to provide the liquid crystal display device which can favorably perform the color compensation for adjustment of color tones in the reflective display while coping with flickers simultaneously.

According to another aspect of the present invention, in a liquid crystal display device which includes a transmissive region and a reflective region within one pixel, a pixel electrode in the transmissive region is formed of a transparent electrode, a pixel electrode in the reflective region is formed of a metal electrode, and a transparent conductive film having a film thickness of 95 nm or more and 105 nm or less is arranged on the metal electrode.

Due to such a constitution, it is possible to provide the liquid crystal display device which can more favorably perform the color compensation for adjustment of color tones in the reflective display while coping with flickers simultaneously.

According to the present invention, it is possible to provide the liquid crystal display device which can perform the color compensation along with the counter measure against flickers in the part-transmissive liquid crystal display device.

### BRIEF DESCRIPTION OF THE DRAWINGS

FIG. 1 is a view showing the constitution of a part-transmissive liquid crystal display device of the present invention;

FIG. 2 is a cross-sectional view taken along a line A-A′ in FIG. 1;

FIG. 3 is a view showing the relationship between a film thickness of an ITO film on a reflective electrode and reflection ratios of light at specific wavelengths according to the present invention;

FIG. 4 is a view showing the constitution of a part-transmissive liquid crystal display device of a related art; and

FIG. 5 is a view showing the constitution of a part-transmissive liquid crystal display device of a related art.

### DETAILED DESCRIPTION OF THE INVENTION

Embodiments of the present invention are explained in detail in conjunction with drawings showing the embodiments hereinafter.

[Embodiment 1]

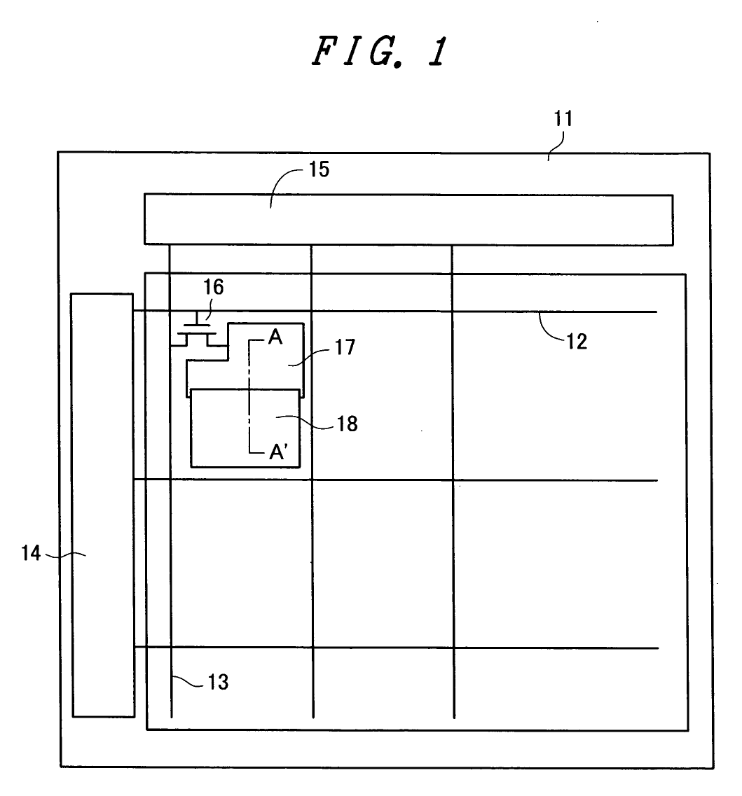

FIG. 1 is a view showing the constitution of a part-transmissive liquid crystal display device of the present invention.

On a substrate 11, a plurality of scanning lines 12 and a plurality of signal lines 13 which are arranged to intersect the plurality of scanning lines 12 are arranged. Pixels are constituted corresponding to regions which are surrounded by these scanning lines 12 and signal lines 13. Further, with respect to these scanning lines 12, a scanning drive circuit 14 which controls the driving of these scanning lines is arranged outside a display region which is formed of the plurality of pixels, while also with respect to the signal lines 13, a signal drive circuit 15 which controls the driving of these signal lines 13 is arranged outside the display region. Here, the scanning drive circuit 14 may be constituted of one semiconductor element or a plurality of semiconductor elements. The same goes for the signal drive circuit 15. Further, the scanning drive circuit 14 and the signal drive circuit 15 may be constituted of one semiconductor element.

In each pixel, a switching element 16 which is formed of a thin film transistor (hereinafter referred to as TFT) or the like is arranged corresponding to an intersecting portion of the scanning line 12 and the signal line 13, a transparent electrode 17 such as an ITO film or the like which forms a transmissive region is connected to the switching element 16, and a reflective electrode 18 in a reflective region is connected to the transparent electrode 17. Here, since the substrate 11 is a substrate on which the TFT which constitutes the switching element is arranged, the substrate 11 may be also referred to as a TFT substrate.

FIG. 2 is a cross-sectional view taken along a line A-A′ in FIG. 1, wherein a right side in FIG. 2 corresponds to an A side in FIG. 1 and a left side in FIG. 2 corresponds to an A′ side in FIG. 1. Although not shown in the drawing, a backlight device is arranged below a liquid crystal panel shown in FIG. 2 thus allowing light from the backlight to pass through the transmissive region “a” from a side below the transmissive region a.

A transparent electrode 17 made of ITO or the like which constitutes the transmissive region “a” is arranged over the substrate 11 shown in FIG. 2, while a reflective electrode 18 which constitutes a reflective region “b” is arranged over the substrate 11 in a state that the reflective electrode 18 gets over the transparent electrode 17 in the vicinity of an end portion thereof. Here, the reflective electrode may be made of aluminum alloy (for example, Al-Nd) as an example.

An organic protective film 22 made of an epoxy resin, for example, is arranged over the substrate 11 in the reflective region “b”, wherein when the above-mentioned reflective electrode 18 is made of aluminum alloy such as Al-Nd, between the organic protective film 22 and the reflective electrode 18, to acquire a favorable ohmic junction, a contact metal 20 made of molybdenum alloy (for example, Mo-Cr) is arranged.

Further, a transparent conductive film 21 made of ITO or the like having a film thickness of 80 nm or more and 120 nm or less is arranged over the reflective electrode 18. The film thickness of the transparent electrode is described later.

On the other hand, over another substrate 19, a common electrode 23 which is constituted by arranging a transparent electrode made of ITO or the like, for example, is arranged. By sandwiching liquid crystal 24 between the substrate 11 (TFT substrate) and another substrate (referred to as a CF substrate since color filters (CF) not shown in the drawing are arranged thereon) 19, the liquid crystal panel is constituted. Here, in the case of this embodiment, a distance d1 is set to 2.4 μm and a distance d2 is set to 5.4 μm.

Next, the film thickness of the transparent conductive film arranged over the reflective electrode in the present invention is explained.

In constituting the liquid crystal panel, the liquid crystal panel is required to satisfy various requirements. The present invention is provided for satisfying requirement to make the color tone of the reflection slightly bluish while obtaining a desired transmissive color tone using a CF pigment which is commonly used by the transmissive portion by making use of the transparent conductive film which is arranged over the reflective electrode which is provided as the countermeasure against flickers in the part-transparent liquid crystal display device. Here, the requirement to make the color tone of the reflection slightly bluish is a requirement which is set as the specification of a product of the present invention.

Table 1 shows the relationship among the specification of the reflective electrode, the film thickness of the ITO film arranged on the reflective electrode, and the absolute reflection ratios at specific wavelengths. Here, the absolute reflection ratio means a reflection ratio when a theoretical reflection ratio of Si is set as 100%.

Table 1 shows, for example, that when the Al-Nd alloy film having a film thickness of 120 nm is arranged over the substrate 11 as the reflective electrode, the Mo-Zr alloy film having a film thickness of 60 nm is arranged below the reflective electrode as the contact metal, and the ITO film is not arranged over the reflective electrode (film thickness of ITO film being 0), 90.93% of light having a wavelength of 450 nm is reflected, 90.334% of light having a wavelength of 550 nm is reflected, and 89.508% of light having a wavelength of 650 nm is reflected. Further, Table 1 also shows that when the Al-Nd alloy film having a film thickness of 120 nm is arranged over the substrate 11 as the reflective electrode, the Mo-Zr alloy film having a film thickness of 61 nm is arranged below the reflective electrode as the contact metal, and the ITO film having a film thickness of 100 nm is arranged over the reflective electrode, 85.568% of the light having the wavelength of 450 nm is reflected, 84.65% of the light having the wavelength of 550 nm is reflected, and 74.732% of the light having the-wavelength of 650 nm is reflected.

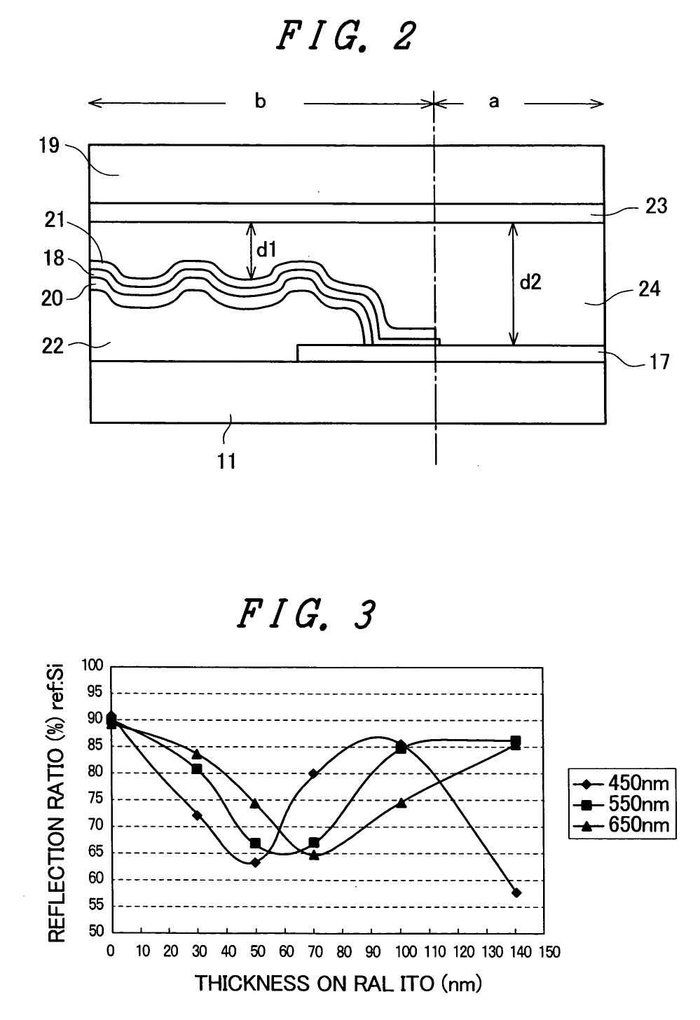

With respect to film thicknesses of other ITO films, results shown in Table 1 are obtained. FIG. 3 shows the relationship with respect to lights of respective wavelengths by taking the film thickness of the ITO film over the reflective electrode on an axis of abscissas and the absolute reflection ratio on an axis of ordinates.

TABLE 1

| specification of | ITO film | wavelength | | |
|---|---|---|---|---|
| reflective electrode | thickness | 450 nm | 550 nm | 650 nm |
| AINd/MoZr = 120/60 | 0 | 90.93 | 90.334 | 89.508 |
| AINd/MoZr = 120/60 | 30 | 72.218 | 80.98 | 83.75 |
| AINd/MoZr = 120/60 | 50 | 63.35 | 66.902 | 74.642 |
| AINd/MoZr = 120/60 | 70 | 79.922 | 66.944 | 64.656 |
| AINd/MoZr = 120/61 | 100 | 85.568 | 84.65 | 74.732 |
| AINd/MoZr = 120/60 | 140 | 57.748 | 86.134 | 85.434 |

As can be understood from FIG. 3, when the film thickness of the ITO film over the reflective electrode is 100 nm, the light having the wavelength of 450 nm and the light having the wavelength of 550 nm exhibit the high reflection ratios which are substantially equal, while the light having the wavelength of 650 nm exhibits the reflection ratio which is lower than the reflection ratios of the lights having the wavelengths of 450 nm and 550 nm.

That is, the reflective electrode exhibits the low reflection with respect to red which is the light having the wavelength of 650 nm and exhibits the substantially equal reflection ratios with respect to blue which is the light having the wavelength of 450 nm and green which is a light having the wavelength of 550 nm. Accordingly, it is found that it is possible to make the color tone of the reflection bluish as a whole in a well-balanced state that only red exhibits the low reflection ratio and blue and green exhibits the substantially equal reflection ratios.

As described above, according to the present invention, in the liquid crystal display device having the transmissive region and the reflective region within one pixel, in constituting the pixel electrode in the transmissive region using the transparent electrode and the pixel electrode in the reflective region using the metal electrode, by arranging the transparent conductive film having the film thickness of 100 nm over the metal electrode, it is possible to provide the liquid crystal display device which the present invention aims at.

Here, the data obtained by the present invention shows that it is preferable to arrange the transparent conductive film having the film thickness of 100 nm on the metal electrode. However, in the actual manufacturing, it is difficult to form the transparent conductive film having the film thickness of 100 nm with no allowance of film thickness. Accordingly, based on the data shown in FIG. 3, even when the transparent conductive film is constituted with the film thickness of equal to or more than 95 nm and equal to 105 nm or less, the advantageous effects of the present invention can be obtained and hence, the transparent conductive film may be arranged with the film thickness thereof which falls within such a range.

Further, even when the film thickness of the transparent conductive film is equal to or more than 90 nm and equal to 110 nm or less, it is possible to obtain the advantageous effects of the present invention to some extent. Still further, we consider that the film thickness of 80 nm or more and 120 nm or less falls within an allowable range.

Here, the data shown in FIG. 3 is data which is obtained using the substrate in a single body (air being present over the transparent electrode film in the reflective portion) and hence, the data differs from data when the substrate is actually assembled in an LCD cell with respect to the color tone correction effect. When the transparent electrode is covered with a high refractive medium such as liquid crystal, a quantity of light which is reflected on a surface of the transparent electrode becomes small and hence, coloring generated by the interference of the transparent electrode film is weak and hence, the color tone becomes weak. Table 2 shows this phenomenon.

TABLE 2

| | | | | Pseudo cell chromaticity | | | | | |
|---|---|---|---|---|---|---|---|---|---|
| thickness of | | | | | | | | | Y |
| ITO film on | TFT substrate chromaticity | | | | | | | | relative |
| AL | x | y | Y | x | y | Y | Δx | Δy | value |
| 25 nm | 0.3662 | 0.4062 | 0.75 | 0.3591 | 0.3936 | 0.65 | 0.000 | 0.000 | 1.00 |
| 30 nm | 0.3673 | 0.3856 | 0.50 | 0.3625 | 0.3912 | 0.56 | 0.003 | −0.002 | 0.86 |
| 77 nm | 0.3339 | 0.3809 | 0.53 | 0.3481 | 0.3821 | 0.54 | −0.011 | −0.0012 | 0.83 |
| 100 nm | 0.3515 | 0.3982 | 0.66 | 0.3515 | 0.3911 | 0.61 | −0.008 | −0.003 | 0.94 |
| 140 nm | 0.3948 | 0.4389 | 0.62 | 0.3766 | 0.4143 | 0.57 | 0.018 | 0.021 | 0.88 |
| AL glass side | 0.3528 | 0.3883 | 0.67 | — | — | — | −0.006 | −0.005 | 1.03 |

Here, the TFT substrate chromaticity means chromaticity of the TFT substrate as a single body, while the pseudo cell chromaticity means chromaticity when refractive index matching oil is sandwiched between the TFT substrate and raw glass.

Here, the present invention is also characterized in that, as shown in FIG. 2, the transparent electrode in the transmissive region is not arranged in the reflective region, the transparent electrode which extends from the transmissive region over the substrate is not arranged in the reflective region, and an organic protective film is arranged over the reflective region.

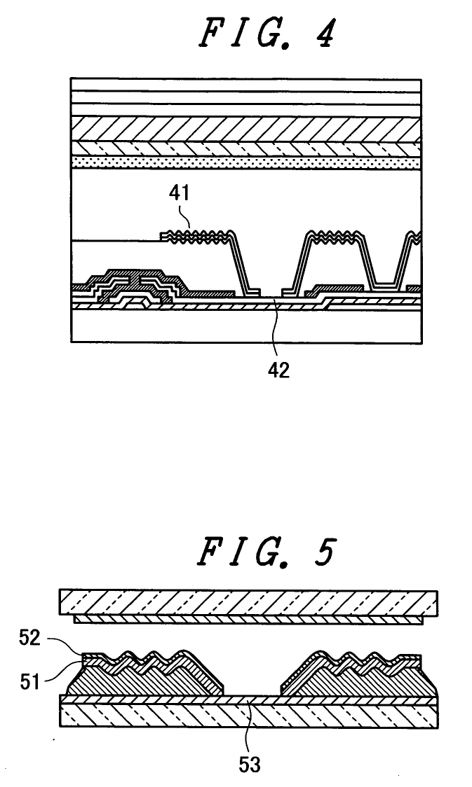

To be more specific, in FIG. 4 and FIG. 5 which are used for explaining a prior art, a transparent electrode in a transmissive region is also arranged in a reflective region irrespective of the transmissive region or the reflective region. However, in the present invention, the transparent electrode in the transmissive region is not arranged in the reflective region. That is, in the present invention, the transparent electrode which is arranged in the transmissive region is not arranged in the reflective region intentionally.

This is because that, to make use of a conventional whole transmissive TFT process, in the present invention, the transparent electrode which is arranged in the transmissive region is not extended to and arranged in the reflective region intentionally.

Due to such a constitution, the liquid crystal display device of the present invention can share the peripheral structure in common with the conventional full transmissive process.

Further, the present invention is, as can be understood from FIG. 1 and FIG. 2, also characterized in that the transparent electrode in the transmissive region is connected to the transistor and, at the same time, the metal electrode in the reflective region is connected to the transparent electrode in the transmissive region.

To be more specific, in FIG. 4 and FIG. 5 which explain the prior art, irrespective of the transmissive region and the reflective region, the transparent electrode in the transmissive region is also arranged in the reflective region. The present invention eliminates such a constitution. That is, in the constitution shown in FIG. 4 and FIG. 5, the transmissive region is formed at a center portion of the pixel and the reflective region is formed in an end portion of the pixel, that is, at a side close to the scanning line of the pixel. The present invention also differs from the prior art with respect to such a constitution.

What is claimed is:

1. A liquid crystal display device including a transmissive region and a reflective region within one pixel, wherein
a pixel electrode in said transmissive region is formed of a transparent electrode,
a pixel electrode in said reflective region is formed of a metal electrode, and
a transparent conductive film having a film thickness of 80 nm or more and 120 nm or less is arranged over said metal electrode.

2. A liquid crystal display device according to claim 1, wherein said transparent electrode which constitutes the pixel electrode of the transmissive region is not arranged in said reflective region.

3. A liquid crystal display device according to claim 1, wherein
said transmissive region is constituted by arranging said transparent electrode which constitutes said pixel electrode of said transmissive region on a substrate which constitutes said liquid crystal display device, and
said reflective region is constituted by arranging an organic protective film on said substrate, by arranging said metal electrode over said organic protective film, and by arranging said transparent conductive film over said metal electrode.

4. A liquid crystal display device according to claim 1, wherein a thin film transistor is arranged on one pixel, said transparent electrode of said transmissive region is connected to said thin film transistor, and said metal electrode on said reflective region is connected to said transparent electrode.

5. A liquid crystal display device according to claim 1, wherein said liquid crystal display device is constituted of a pair of substrates and a liquid crystal layer which is sandwiched by said pair of substrates, and
one pixel is formed corresponding to a region which is surrounded by a plurality of scanning lines and a plurality of signal lines which intersect the scanning lines on one substrate of said pair of substrates.

6. A liquid crystal display device according to claim 5, wherein
a thin film transistor is arranged in one pixel, and said transparent electrode in said transmissive region is connected to said thin film transistor, and
said metal electrode on said reflective region is connected to said transparent electrode.

7. A liquid crystal display device including a transmissive region and a reflective region within one pixel, wherein
a pixel electrode in said transmissive region is formed of a transparent electrode,
a pixel electrode in said reflective region is formed of a metal electrode, and
a transparent conductive film having a film thickness of 90 nm or more and 110 nm or less is arranged over said metal electrode.

8. A liquid crystal display device according to claim 7, wherein said transparent electrode which constitutes said pixel electrode of said transmissive region is not arranged in said reflective region.

9. A liquid crystal display device according to claim 7, wherein
said transmissive region is constituted by arranging said transparent electrode which constitutes said pixel electrode of said transmissive region on a substrate which constitutes said liquid crystal display device, and
said reflective region is constituted by arranging an organic protective film on said substrate, by arranging said metal electrode over said organic protective film, and by arranging said transparent conductive film on said metal electrode.

10. A liquid crystal display device according to claim 7, wherein a thin film transistor is arranged on one pixel, said transparent electrode of said transmissive region is connected to said thin film transistor, and
said metal electrode on said reflective region is connected to said transparent electrode.

11. A liquid crystal display device according to claim 7, wherein said liquid crystal display device is constituted of a pair of substrates and a liquid crystal layer which is sandwiched by said pair of substrates, and
one pixel is formed corresponding to a region which is surrounded by a plurality of scanning lines and a plurality of signal lines which intersect said plurality of scanning lines on one substrate of said pair of substrates.

12. A liquid crystal display device according to claim 11, wherein
a thin film transistor is arranged in one pixel,
said transparent electrode in said transmissive region is connected to said thin film transistor, and
said metal electrode on said reflective region is connected to said transparent electrode.

13. A liquid crystal display device including a transmissive region and a reflective region within one pixel, wherein
a pixel electrode in said transmissive region is formed of a transparent electrode,
a pixel electrode in said reflective region is formed of a metal electrode, and
a transparent conductive film having a film thickness of 95 nm or more and 105 nm or less is arranged on said metal electrode.

14. A liquid crystal display device according to claim 13, wherein said transparent electrode which constitutes said pixel electrode of said transmissive region is not arranged in said reflective region.

15. A liquid crystal display device according to claim 13, wherein
said transmissive region is constituted by arranging said transparent electrode which constitutes the pixel electrode of said transmissive region on a substrate which constitutes said liquid crystal display device, and
said reflective region is constituted by arranging an organic protective film on said substrate, by arranging said metal electrode over said organic protective film, and by arranging said transparent conductive film on said metal electrode.

16. A liquid crystal display device according to claim 13, wherein a thin film transistor is arranged on one pixel,
said transparent electrode of said transmissive region is connected to said thin film transistor, and
said metal electrode on the reflective region is connected to said transparent electrode.

17. A liquid crystal display device according to claim 13, wherein said liquid crystal display device is constituted of a pair of substrates and a liquid crystal layer which is sandwiched by the pair of substrates, and
one pixel is formed corresponding to a region which is surrounded by a plurality of scanning lines and a plurality of signal lines which intersect said plurality of scanning lines on one substrate of the pair of substrates.

18. A liquid crystal display device according to claim 17, wherein
a thin film transistor is arranged in one pixel,
said transparent electrode in said transmissive region is connected to said thin film transistor, and
said metal electrode on the reflective region is connected to the transparent electrode.
